(19) United States
(12) Patent Application Publication
(10) Pub. No.: US 2009/0078478 A1
(43) Pub. Date: Mar. 26, 2009

(54) Finger tip stylus

(76) Inventor: Jonathan Newman, Boulder, CO (US)

Correspondence Address: RUTH EURE, 4795 EDISON AVENUE, BOULDER, CO, 80301, US

(21) Appl. No.: 11/903,599

(22) Filed: Sep. 24, 2007

(51) Int. Cl. G06F 3/033

(52) U.S. Cl. 178/19.01

(57) ABSTRACT

The present invention provides a flexible finger tip stylus in a variety of configurations which can be worn on one or more fingers of a user to facilitate touching keys on a keypad, keyboard, or to close, expand or minimize a window or enter other data where needed or activate portions of a screen on a touch screen device without the need to use the entire hand to hold a pen-like stylus. The device can be made of any a variety of materials including, but not limited to: closed cell resin, flexible nylon, any flexible thermoplastic material, latex, plastic composites including latex, elastic, rubber, fabrics including elastic or lycra, and spandex, for example.

### FIELD OF THE INVENTION

The present invention relates to the field of accessories for hand held-electronic devices such as phones, palm pilots, PDA's, gaming devices and the like.

### BACKGROUND OF THE INVENTION

This invention relates to a finger tip stylus for small keyboard devices, cell phones and “touch screen” devices. “Touch screen” devices are devices that can sense and record when an object contacts the surface of the screen. Particularly, this invention is directed to a finger tip stylus for such devices that the user can wear on or attached to their finger.

Handheld electronic devices having touch sensitive screens include, for example, personal digital assistants (“PDA's”) such as the Microsoft Windows CE based handheld PC's, the Apple iphone and Nintendo Ds, or personal organizers such as the Sharp Zaurus, for example. These computing devices typically include a simple wooden or plastic pen-type stylus with a non-marking tip. The stylus is touched to the screen such as the HP touchsmart and Tablet PCs in order to act like a mouse (to move the cursor, highlight text, etc.) or to enter information (characters for handwriting recognition, drawings, etc.) A non-marking implement is used so that the screen of the device will not be scratched or damaged when touched. In addition, these pen-style styli must usually be over four inches (10 cm.) long to be properly supported by a user's hand. This requires a significant amount of space within the case of a touch screen device, for storage of the stylus.

Moreover, the stylus for such devices is often lost. Replacement styli may not be available. In addition, existing styli are pen-shaped. This requires the user to stop what they are doing and pick up or put down these specialized styli when they wish to enter information in the touch screen device while doing other work such as typing or writing. In place of the normal stylus a user will occasionally use a fingertip as a stylus; unfortunately a fingertip is blunt and a user often cannot position their finger with sufficient accuracy to locate the cursor, close, expand or minimize a window or enter other data where needed on the screen.

The present invention provides a solution to this problem by providing a stylus which can be worn on the finger of the user. Using the present invention not only solves the problem of the lost stylus, but also affords the user use of hands and fingers for other things while at the same time giving the user the ability to enter information on the screen.

Two patents have issued regarding digital styli to the A. T. Cross Company. These U.S. Pat. Nos. 5,635,682 and 5,627,348 cover the creation of a replaceable non-marking stylus core in conventional pen-shaped writing instruments, and the composition of the non-marking stylus tip that will produce a “sound and feel” comparable to traditional writing on paper. Neither of these inventions contemplate the use of a non-marking stylus attached to or covering a portion of a user's finger.

Other prior art contemplates the use of a writing implement, i.e., a pencil or pen, attached to a finger. For example, U.S. Pat. No. 198,484 of 1877 uses a perforated finger sleeve to attach a pen, “a pencil or other writing or marking instrument” to one's finger. Other patents, including U.S. Pat. No. 361,535 of 1887, and U.S. Pat. No. 5,405,206, use an assortment of rings, metal clamps or thimble type devices to attach writing instruments (most of which use ink or some other physical marking process) to one's finger. U.S. Pat. No. 4,738,556 uses a Velcro strap to secure a pen in-line with the end of a finger. A recent fingertip stylus device has been shown on the Internet. The device is a rotatable bent wire ring including a tip extension for contacting a touch screen. Still other prior art contemplates the use of finger mounted writing implements for digital tablets, however, these patents contemplate use of devices which gather or send electrical signals from the device tips and do not contemplate a passive, non-marking tip. These patents include U.S. Pat. No. 4,954,817 and U.S. Pat. No. 5,706,026.

U.S. Pat. No. 6,249,277 to Varveris describes a finger-mounted stylus comprising a flexible non-metallic elastic ring or a fabric-like strap which fastens around the first flange of the finger of the user. The strap supports a rod which extends through a loophole in the strap. The end of the rod can be used as a stylus. The device of Varveris covers only the distal phalange of the user.

### SUMMARY OF THE INVENTION

In contrast to the prior art, the finger tip stylus of the present invention is a one-piece device which fits over the finger tip of the user having an integral stylus point.

Generally, the purpose of the device is to provide a stylus for touch screen devices and small keyboard or keypad devices that the user can wear on or attached to their finger. It will allow a user to enter data on a keypad, keyboard or on a touch screen without having to hold a separate stylus or pen-type implement, and will allow the user to type on a keyboard or hold a normal pen or pencil without having to remove or adjust the finger tip stylus.

It is an object of the present invention to provide a finger tip stylus which can worn by a user to touch keys on a keypad, keyboard, or to activate portions of a screen on a touch screen device or a touchscreen keyboard or an appropriate device to be developed in the future.

It is an object of the present invention to provide a finger tip stylus which can be worn on the first two phalanges of any finger.

It is a further object of the present invention to provide a finger tip stylus which can be molded in one piece from thermoplastic material.

It is a further object of the present invention to provide a finger tip stylus which can be made from one material.

It is a further object of the present invention to provide a finger tip stylus which can be made from more than one material.

It is a further object of the present invention to provide a finger tip stylus for use in public retail and other settings for hygienic use of credit card machines.

### BRIEF DESCRIPTION OF THE DRAWINGS

FIG. 1 is a perspective view of one embodiment of the finger tip stylus of the present invention mounted on a finger tip of a user.

FIG. 2 is a side view of the embodiment of FIG. 1 of the finger tip stylus of the present invention mounted on a finger tip of a user.

FIG. 3 is another side view of the embodiment of FIG. 1 of the finger tip stylus of the present invention mounted on a finger tip of a user.

FIG. 4 is a top view of an alternative embodiment of the finger tip stylus of the present invention not mounted on a finger tip of a user.

FIG. 5 is a bottom view of an alternative embodiment of the finger tip stylus of the present invention not mounted on a finger tip of a user.

FIG. 6 is a distal end view of an alternative embodiment of the finger tip stylus of the present invention not mounted on a finger tip of a user.

FIG. 7 is a proximal end view of an alternative embodiment of the finger tip stylus of the present invention not mounted on a finger tip of a user.

FIG. 8 is a perspective view of an alternative embodiment of the finger tip stylus of the present invention mounted on a finger tip of a user.

FIG. 9 is a side view of the embodiment of FIG. 8 of the finger tip stylus of the present invention mounted on a finger tip of a user.

FIG. 10 is another side view of the embodiment of FIG. 8 of the finger tip stylus of the present invention mounted on a finger tip of a user.

FIG. 11 is a top view of the embodiment of FIG. 8 of the finger tip stylus of the present invention mounted on a finger tip of a user.

FIG. 12 is a bottom view of the embodiment of FIG. 8 of the finger tip stylus of the present invention mounted on a finger tip of a user.

FIG. 13 is a distal end view of the embodiment of FIG. 8 of the finger tip stylus of the present invention not mounted on a finger tip of a user.

FIG. 14 is a proximal end view of the embodiment of FIG. 8 of the finger tip stylus of the present invention not mounted on a finger tip of a user.

FIG. 15 is a perspective view of an alternative embodiment of the finger tip stylus of the present invention mounted on a finger tip of a user.

FIG. 16 is a side view of the embodiment of FIG. 15 of the finger tip stylus of the present invention mounted on a finger tip of a user.

FIG. 17 is another side view of the embodiment of FIG. 15 of the finger tip stylus of the present invention mounted on a finger tip of a user.

FIG. 18 is a top view of the embodiment of FIG. 15 of the finger tip stylus of the present invention mounted on a finger tip of a user.

FIG. 19 is a bottom view of the embodiment of FIG. 15 of the finger tip stylus of the present invention mounted on a finger tip of a user.

FIG. 20 is a distal end view of the embodiment of FIG. 15 of the finger tip stylus of the present invention not mounted on a finger tip of a user.

FIG. 21 is a proximal end view of the embodiment of FIG. 15 of the finger tip stylus of the present invention not mounted on a finger tip of a user.

FIG. 22 is a perspective view of an alternative embodiment of the finger tip stylus of the present invention mounted on a finger tip of a user.

FIG. 23 is a side view of the embodiment of FIG. 22 of the finger tip stylus of the present invention mounted on a finger tip of a user.

FIG. 24 is another side view of the embodiment of FIG. 22 of the finger tip stylus of the present invention mounted on a finger tip of a user.

FIG. 25 is a top view of the embodiment of FIG. 22 of the finger tip stylus of the present invention mounted on a finger tip of a user.

FIG. 26 is a bottom view of the embodiment of FIG. 22 of the finger tip stylus of the present invention mounted on a finger tip of a user.

FIG. 27 is a distal end view of the embodiment of FIG. 22 of the finger tip stylus of the present invention not mounted on a finger tip of a user.

FIG. 28 is a proximal end view of the embodiment of FIG. 22 of the finger tip stylus of the present invention not mounted on a finger tip of a user.

FIG. 29 is a perspective view of an alternative embodiment of the finger tip stylus of the present invention mounted on a finger tip of a user.

FIG. 30 is a side view of the embodiment of FIG. 29 of the finger tip stylus of the present invention mounted on a finger tip of a user.

FIG. 31 is another side view of the embodiment of FIG. 29 of the finger tip stylus of the present invention mounted on a finger tip of a user.

FIG. 32 is a top view of the embodiment of FIG. 29 of the finger tip stylus of the present invention mounted on a finger tip of a user.

FIG. 33 is a bottom view of the embodiment of FIG. 29 of the finger tip stylus of the present invention mounted on a finger tip of a user.

FIG. 34 is a distal end view of the embodiment of FIG. 29 of the finger tip stylus of the present invention not mounted on a finger tip of a user.

FIG. 35 is a proximal end view of the embodiment of FIG. 29 of the finger tip stylus of the present invention not mounted on a finger tip of a user.

FIG. 36 is a perspective view of an alternative embodiment of the finger tip stylus of the present invention mounted on a finger tip of a user.

FIG. 37 is a side view of the embodiment of FIG. 36 of the finger tip stylus of the present invention mounted on a finger tip of a user.

FIG. 38 is another side view of the embodiment of FIG. 36 of the finger tip stylus of the present invention mounted on a finger tip of a user.

FIG. 39 is a top view of the embodiment of FIG. 36 of the finger tip stylus of the present invention mounted on a finger tip of a user.

FIG. 40 is a bottom view of the embodiment of FIG. 36 of the finger tip stylus of the present invention mounted on a finger tip of a user.

FIG. 41 is a distal end view of the embodiment of FIG. 36 of the finger tip stylus of the present invention not mounted on a finger tip of a user.

FIG. 42 is a proximal end view of the embodiment of FIG. 36 of the finger tip stylus of the present invention not mounted on a finger tip of a user.

FIG. 43 is a perspective view of an alternative embodiment of the finger tip stylus of the present invention mounted on a finger tip of a user showing decorative embellishments.

FIG. 44 is a perspective view of an alternative embodiment of the finger tip stylus of the present invention mounted on a finger tip of a user showing decorative embellishments.

FIG. 45 is a perspective view of an alternative embodiment of the finger tip stylus of the present invention mounted on a finger tip of a user showing decorative embellishments.

### DETAILED DESCRIPTION OF THE INVENTION

The present invention comprises a device for attaching to the middle and distal phalanges of any human finger. Stability is enhanced by attaching to both the first and second phalanges of the finger of the user.

The present invention can be made of a variety of materials. Materials suitable for use in the present invention include, but are not limited to: closed cell resin, flexible nylon, any flexible thermoplastic material, latex, plastic composites including latex, elastic, rubber, fabrics including elastic or lycra, and spandex, for example.

The material should have enough elasticity to stay on the finger tip of the user. The material can be vented, or of breathable material for comfort and to avoid perspiration. The material can be of a variety of colors.

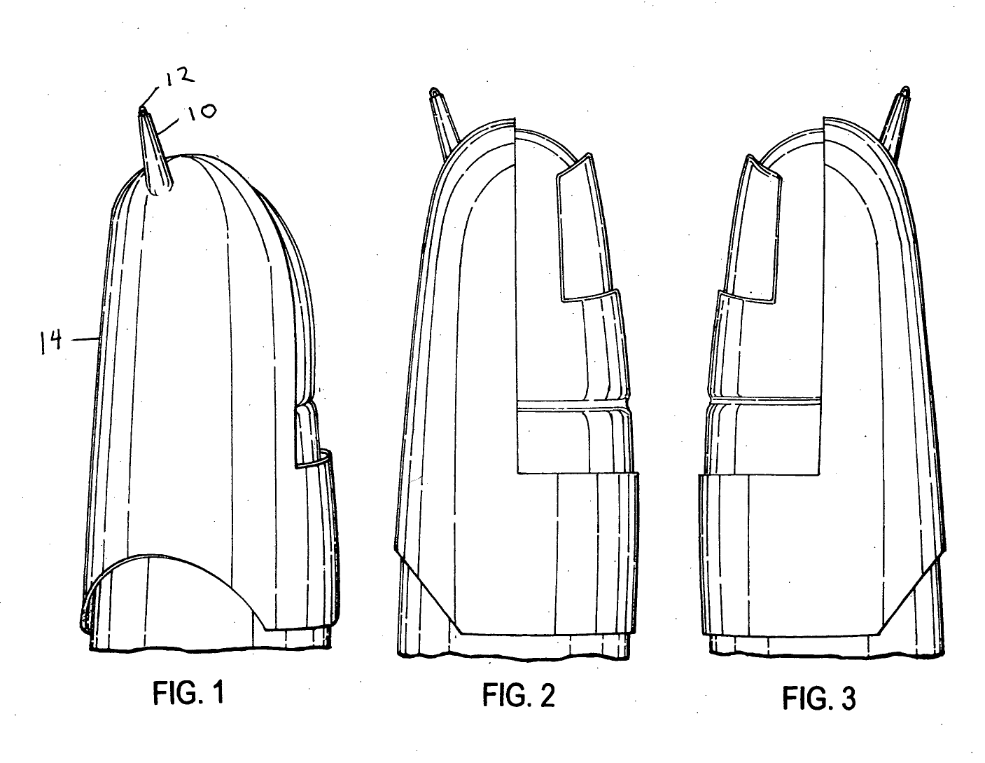

Please refer to FIG. 1. Shaft 10 describes a truncated conical element having the base of the cone at its first end and the truncated point of the cone at is second end. Shaft 10 attaches to the finger cover 14 at its first end and terminates in tip 12 at its second end. The shaft 10 can be made of the same material as the finger cover 14. The tip 12 can also be made of the same material as the shaft 10 and finger cover 14. The tip 12 can be made of different material than the shaft 10 and finger cover 14. If the material to be used for the finger cover 14 is fabric, lycra, spandex or other material which does not have sufficient elastic modulus to maintain adequate rigidity for touching keys or a screen without deformation, then it may be necessary for tip 12 to be made from more rigid material. If the material to be used for the finger cover 14 is fabric, lycra or other material which does not have sufficient elastic modulus to maintain adequate rigidity for touching keys or a screen without deformation, then it may be necessary for shaft 10 and tip 12 to be made from more rigid material.

In addition to making tip 12 out of more thermoplastic material, tip 12 can be made of magnetic material, if desired, to facilitate the activation of a touch screen. Also, it is contemplated that electrically conductive material such as copper, for example, could be used for the tip 12. If a conductive tip is used, a grounding wire leading from the tip may also be incorporated into the device.

If the device is made from a closed cell resin polymer, or other polymer, it may be sufficient to make the entire device from one material.

Shaft 10 protrudes from the finger cover 14 at an appropriate angle to allow minimal movement of the finger of the user to touch the key or activate the screen. Any angle can be used, however, an angle of approximately 30 to 45 degrees from the axis of the finger may be optimal for this purpose.

The length of shaft 10 can be any length which permits the user to comfortable touch the key or activate the screen, however, a length of from about ⅛ inch to about ⅜ inch may be optimal.

FIG. 2 shows a side view of one embodiment of the present invention which has a full cut away portion to allow for any length of fingernail of the user.

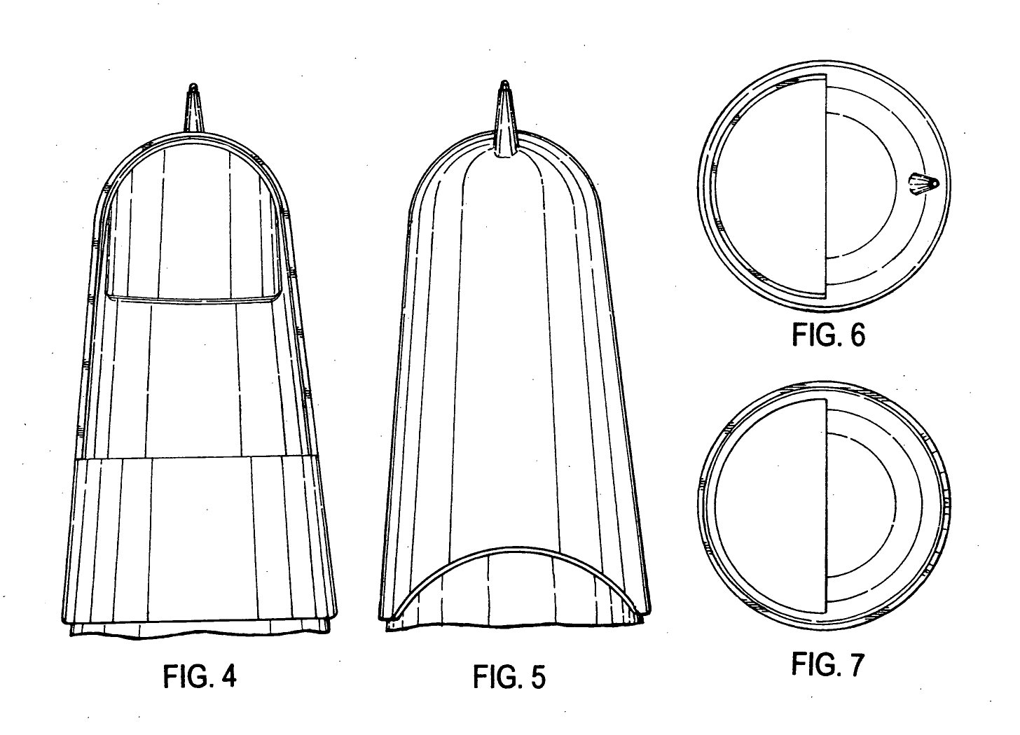

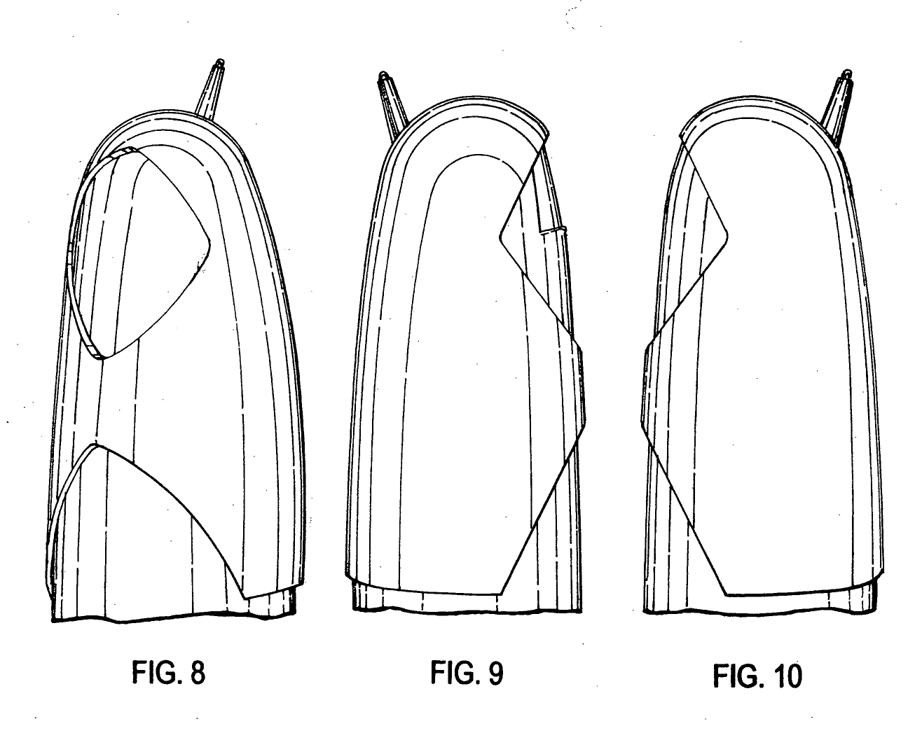

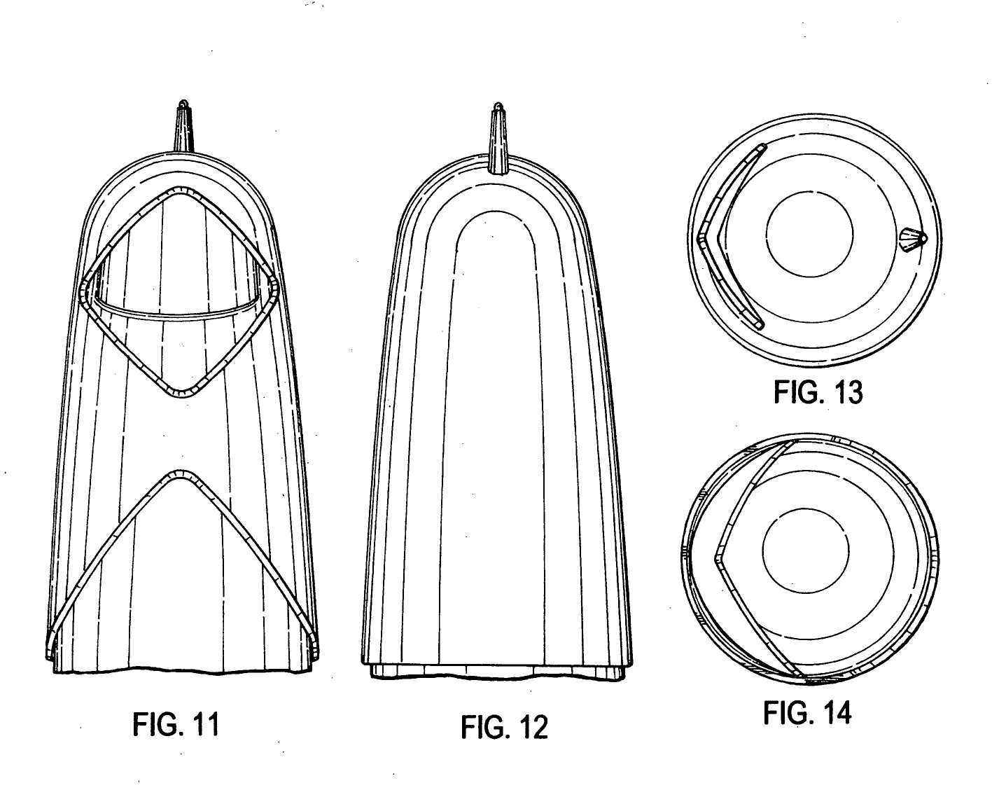

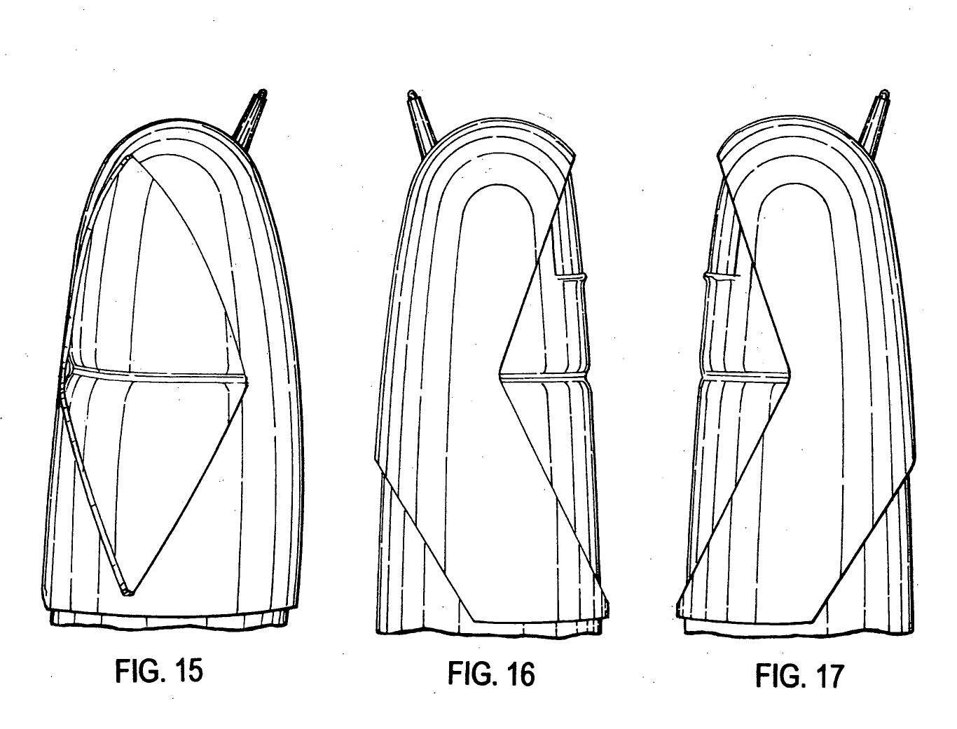

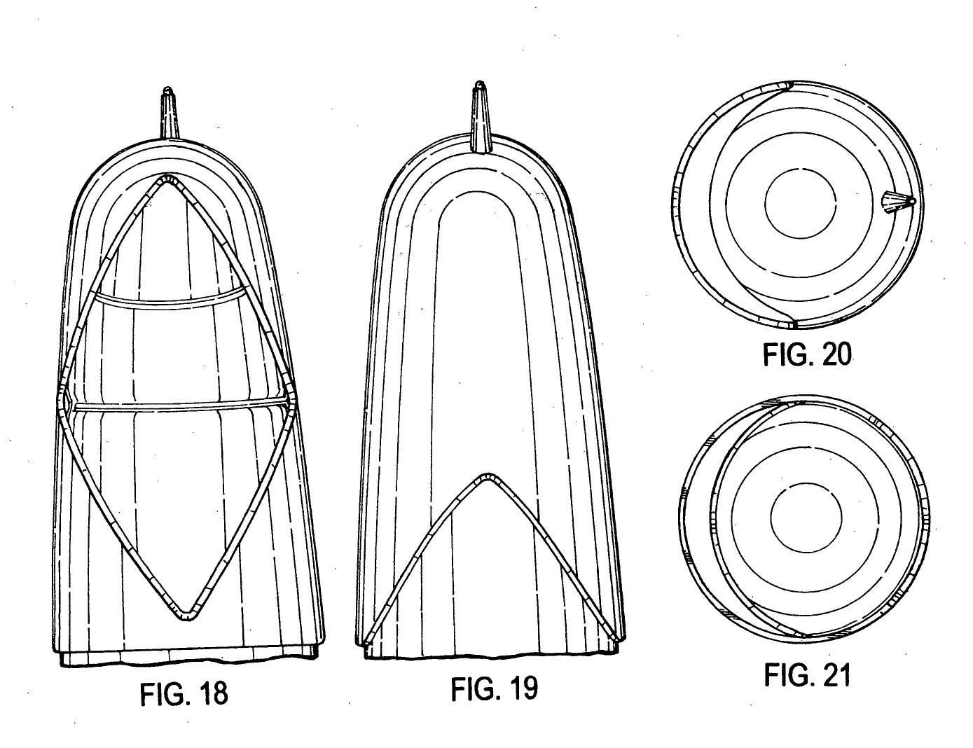

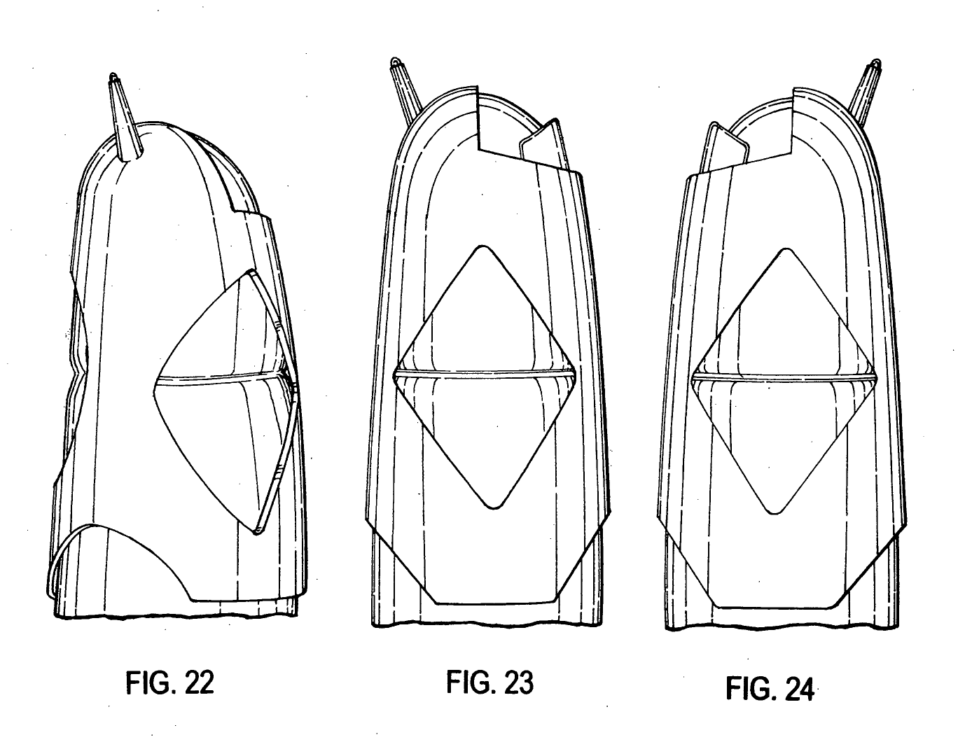

FIG. 4 shows an alternative embodiment of the present invention which comprises a finger cover having a cross element which covers the top of the finger of the user at a different position than the embodiment of FIG. 1.

FIG. 8 shows yet another alternative embodiment of the present invention which comprises a finger cover having more finger coverage than the device shown in FIGS. 1 and 4, and openings at curvilinear angles.

FIG. 15 shows yet another alternative embodiment of the present invention which comprises a finger cover having a larger opening over the knuckle than the embodiment of FIG. 8

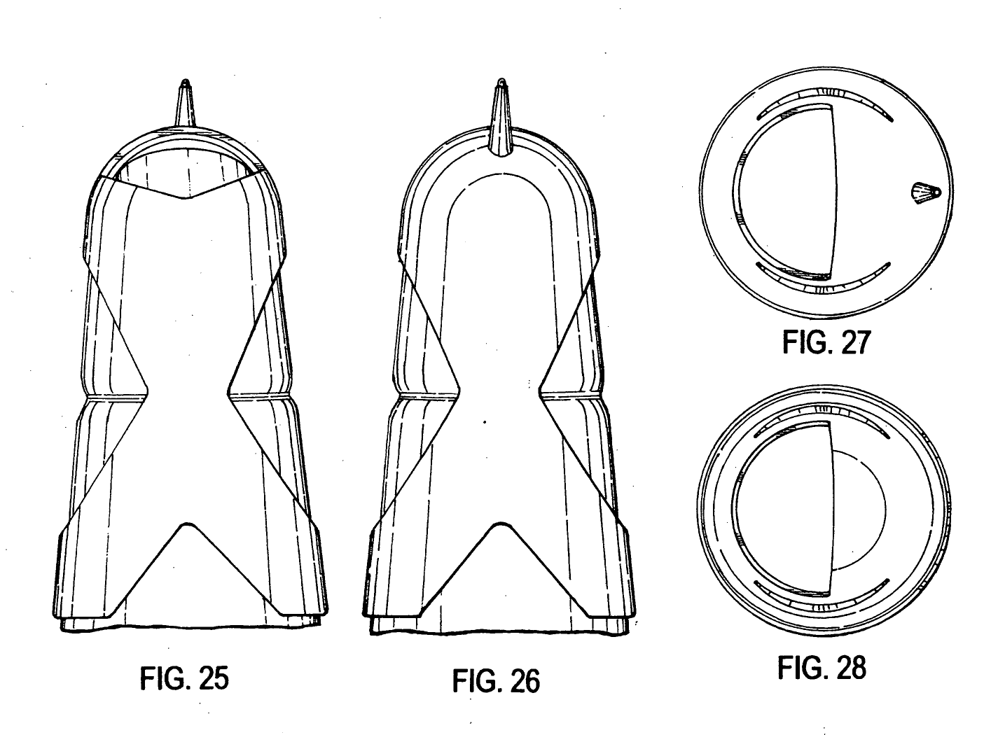

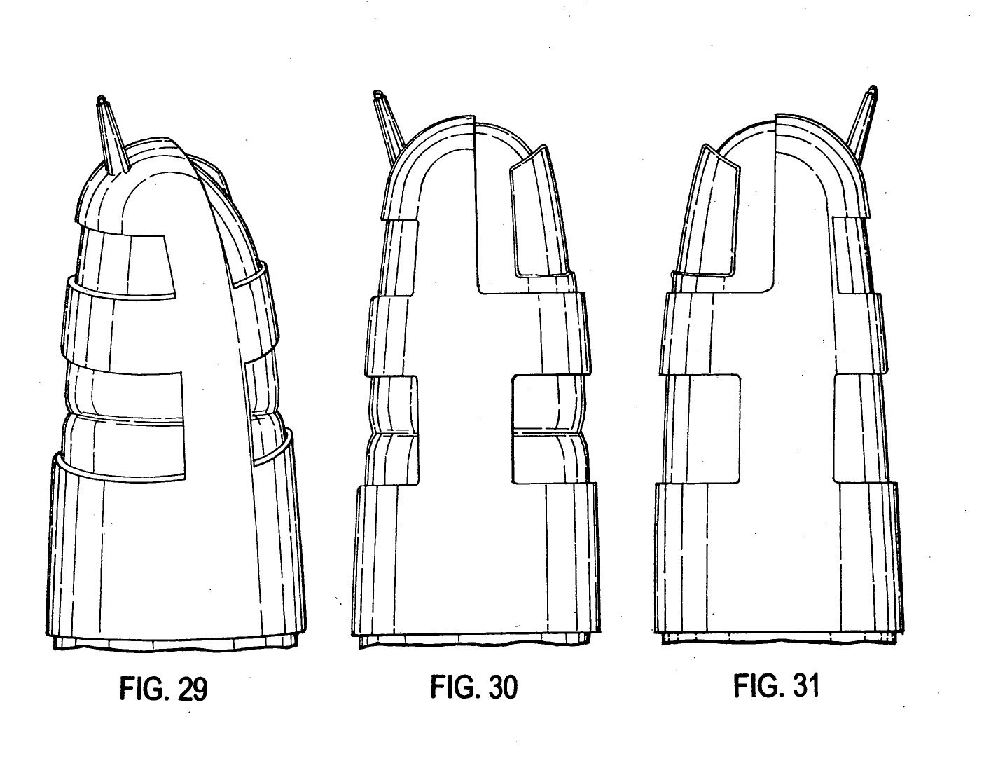

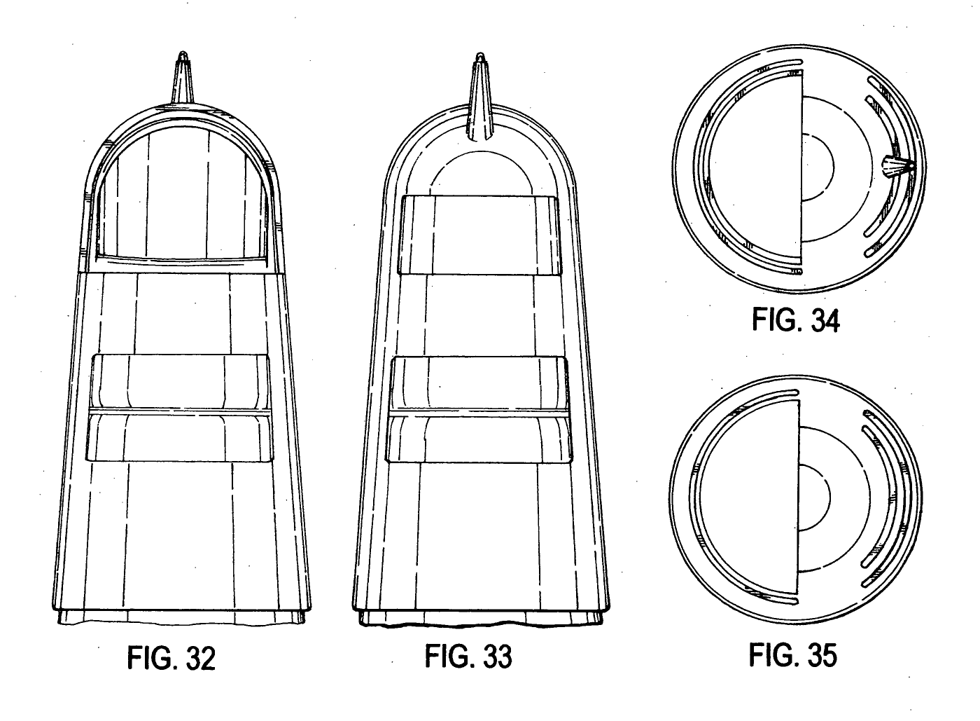

FIG. 25 shows yet another alternative embodiment of the present invention which comprises a finger cover having a criss-cross pattern over the knuckle of the user.

FIG. 29 shows yet another alternative embodiment of the present invention which comprises a finger cover having an orthogonal pattern over the finger of the user.

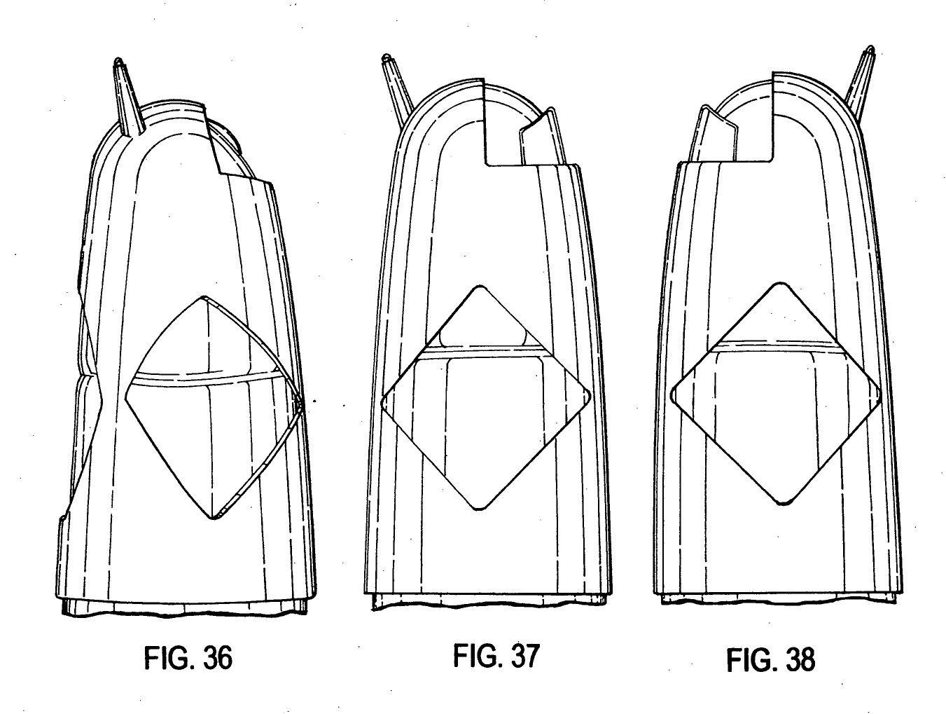

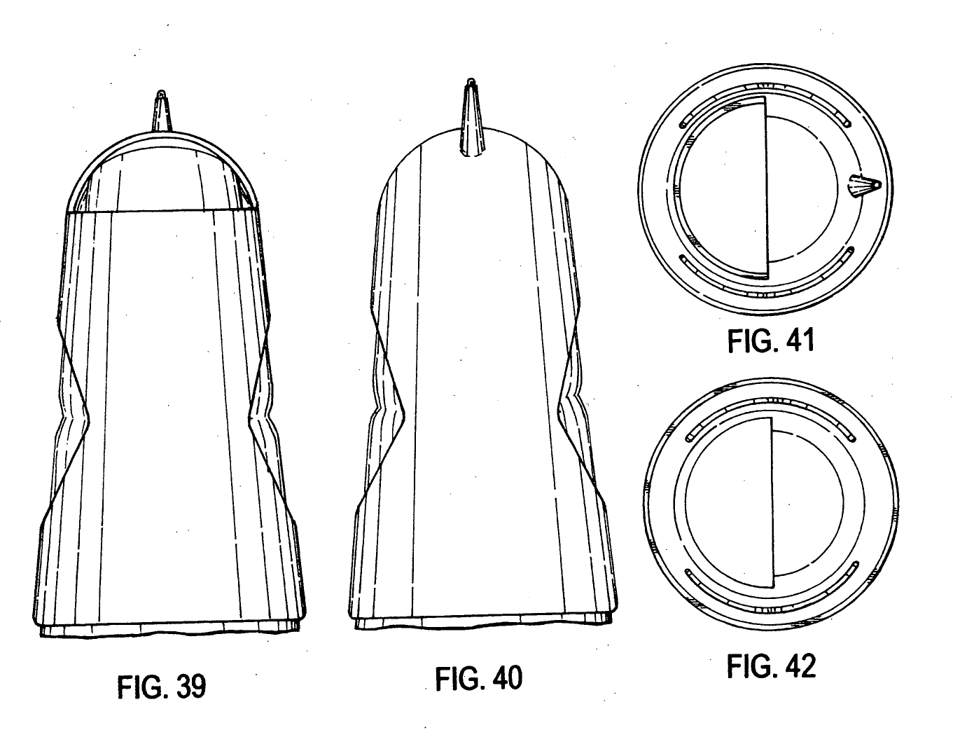

FIG. 36 shows yet another alternative embodiment of the present invention which comprises a finger cover having a cut away for allowing extended fingernails to protrude from the device.

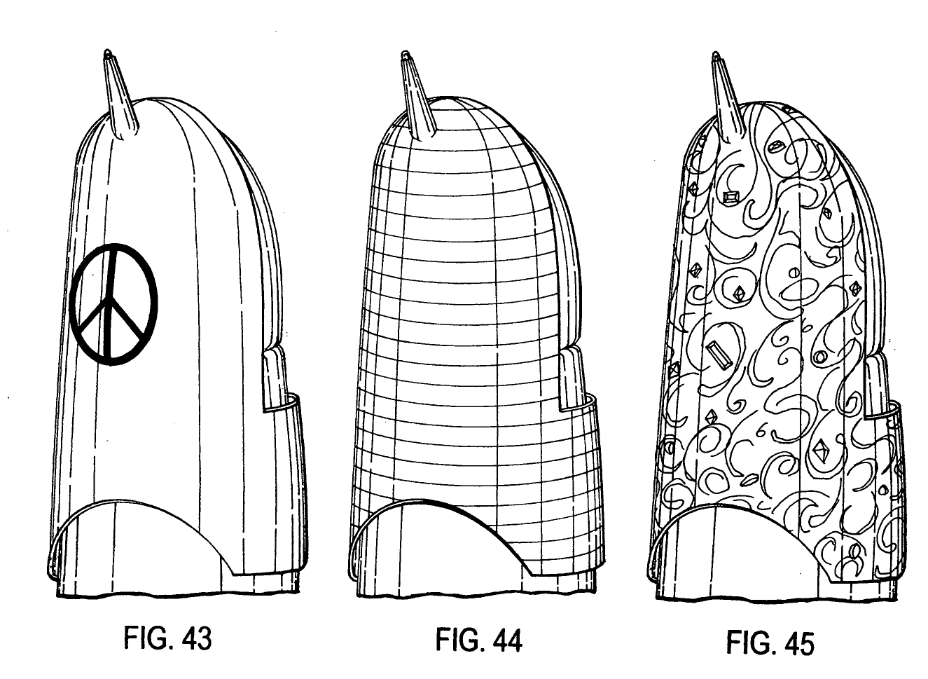

FIGS. 43 through 45 show possible embellishments to the device which embellishments can include, texturing, coloring, imbedding with rhinestones, metallic fibers or any other decoration which he user may desire, and which does not interfere with the functioning of the device.

The openings of these various designs may be reinforced with stitching to provide added strength to the elastomeric material.

The device may be packaged in a “rolled up” configuration, and the stylus tip 12 may be placed at the desired location on the finger tip and the body of the finger cover 14 can be unrolled to embrace the finger.

It is contemplated that more than one device can be worn by a user at one time to facilitate data entry and typing on a touchscreen keypad.

It is also contemplated that the device may have an auxiliary ring for attachment to a key ring, or belt loop or other attachment means for ready access.

It is contemplated that this device will provide “touch screen” access to persons otherwise unable to access such devices. These persons may include but are not limited to, for example, people who are overweight, vision impaired, impaired motor control, carpel tunnel syndrome, or other physical disability which would make use of a touch screen or small keyboard or key pad difficult.

It is also contemplated that the present invention would enable persons of impaired dexterity to draw or design on a touch screen.

It is also contemplated that the present invention could be used as an adjunct to a prosthetic arm or hand device to enable such a person to utilize a touch screen or keypad or keyboard device.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A finger tip stylus comprising:
a) a finger cover for holding the stylus on at least one phalange of a finger,
b) a shaft for supporting a tip, and
c) a tip for making contact with a keypad, keyboard or touchscreen.

2. The finger tip stylus of claim 1 wherein the shaft having a first end and a second end describes a truncated conical element having the base of the cone at its first end and the truncated point of the cone at is second end and the tip is located at the second end of the shaft.

3. The finger tip stylus of claim 2 wherein the shaft can be made of the same material as the finger cover.

4. The finger tip stylus of claim 3 wherein the tip is made of the same material as the shaft and the finger cover.

5. The finger tip stylus of claim 3 wherein the tip is made of different material than the shaft and finger cover.

6. The finger tip stylus of claim 1 wherein the shaft is made of different material than the finger cover.

7. The finger tip stylus of claim 3 wherein the material is selected from the group consisting of: closed cell resin, flexible nylon, any flexible thermoplastic material, latex, plastic composites including latex, elastic, rubber, fabrics including elastic or lycra, and spandex.

8. The finger tip stylus of claim 4 wherein the materials are selected from the group consisting of: closed cell resin, flexible nylon, any flexible thermoplastic material, latex, plastic composites including latex, elastic, rubber, fabrics including elastic or lycra, and spandex.

9. The finger tip stylus of claim 5 wherein the materials are selected from the group consisting of: closed cell resin, flexible nylon, any flexible thermoplastic material, latex, plastic composites including latex, elastic, rubber, fabrics including elastic or lycra, and spandex.

10. The finger tip stylus of claim 6 wherein the materials are selected from the group consisting of: closed cell resin, flexible nylon, any flexible thermoplastic material, latex, plastic composites including latex, elastic, rubber, fabrics including elastic or lycra, and spandex.

11. The finger tip stylus of claim 1 wherein the shaft protrudes from the finger cover at an appropriate angle to allow minimal movement of the finger of the user to touch the key or activate the screen.

12. The finger tip stylus of claim 8 wherein the appropriate angle is about 30 to about 45 degrees from the axis of the finger.

13. The finger tip stylus of claim 2 wherein the length of shaft can be any length which permits the user to touch the key or activate the screen.

14. The finger tip stylus of claim 13 wherein the length of the shaft is from about ⅛ inch to about ⅜ inch.

15. The finger tip stylus of claim 5 wherein the tip is made of electrically conductive material.

16. The finger tip stylus of claim 15 further comprising a grounding wire leading from the tip.

17. The finger tip stylus of claim 5 wherein the tip is made of magnetic material.
